(19) United States
(12) Patent Application Publication
(10) Pub. No.: US 2008/0204520 A1
(43) Pub. Date: Aug. 28, 2008

(54) Print Head and a Method of Print Head Operation with Compensation for Ink Supply Pressure Variation

(75) Inventors: Haggai Karlinski, Ramat Chen (IL); Gil Fisher, Shoham (IL)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: HEWLETT-PACKARD DEVELOPMENT COMPANY, L.P.

(21) Appl. No.: 12/066,008

(22) PCT Filed: Sep. 11, 2006
(86) PCT No.: PCT/IL06/01058

§ 371 Date: Mar. 6, 2008

(30) Foreign Application Priority Data
Sep. 12, 2005 (IL) 170798

(51) Int. Cl. B41J 2/045

(52) U.S. Cl. 347/71

(57) ABSTRACT

Disclosed is an inkjet print head for ejecting ink droplets, the print head comprises a micro machined chip, a holder that holds the chip and a manifold made as a recess in the holder for distributing ink to the micro machined chip. Sidewalls form the manifold. At least one of the sidewalls forming the manifold is a flexible sidewall. The sidewall deforms as a function of the print head operational pattern and changes the manifold volume such that it maintains ink pressure constant.

### TECHNOLOGY FIELD

The present print head and method relate to digital printing and particularly to inkjet printing with inkjet print heads.

### BACKGROUND

Inkjet printing is a well known in the art printing method. The basics of this technology are described, for example by Jerome L. Johnson “Principles of Non-impact Printing”, Palatino Press, 1992, Pages 302-336. ISBN 0-9618005-2-6. Commercial products such as computer printers, large format graphics printers and others exist.

An ink-jet print head consists of an array or a matrix of ink nozzles, with each nozzle selectively ejecting ink droplets. The number of operating nozzles and drop volume establish the ink flow from an ink tank, which may be an intermediary ink tank placed in close proximity to the print head or remote tank. When printing average density images the print head on average consumes steady amounts of ink. Sudden changes in ink consumption occur at the beginning and the end of the printing process. Significant changes in ink consumption may take place when sudden shifts from highlights to shadows exist in the printed image. These changes cause air through nozzle ingestion; adversely affect the print head operation and the quality of the printed image.

European Patent EP 0 956 958 B1 teaches certain techniques of reducing the influence of sudden ink consumption changes.

### BRIEF LIST OF DRAWINGS

The print head structure and operation method are particularly pointed out and distinctly claimed in the concluding portion of the specification. The print head and the method, however, both as to architecture and method of operation, may best be understood by reference to the following detailed description when read with the accompanied drawings, in which like reference characters refer to the same parts throughout the different views. The drawings are not necessarily to scale, emphasis instead being placed upon illustrating the principles of the method.

FIGS. 1A-1C are schematic illustrations of the first embodiment of an inkjet print head.

FIG. 2 is a cross section of the print head of the first embodiment.

FIG. 3 is a schematic illustration of the pressure changes within a conventional print head at the beginning of print head operation.

FIG. 4 is a schematic illustration demonstrating principles of operation of the flexible sidewall.

FIG. 5 is a schematic illustration of the pressure changes within the print head of the first embodiment at the beginning of print head operation.

FIGS. 6A and 6B illustrate different geometrical sizes of the flexible cover.

FIG. 7 is a schematic illustration of a printed image with multiple highlight shadow transitions.

FIG. 8 is a schematic illustration of the second embodiment of the inkjet print head.

### DETAILED DESCRIPTION OF THE EXEMPLARY EMBODIMENTS

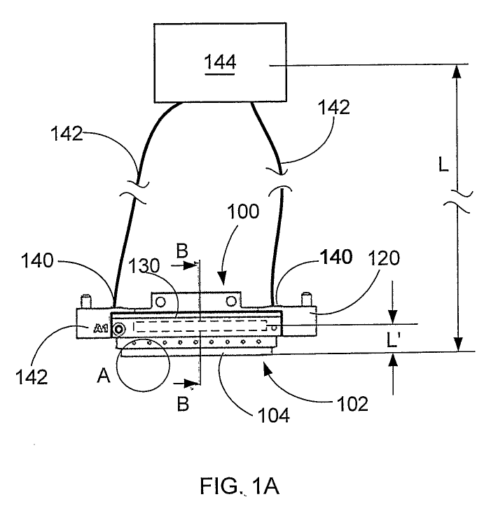

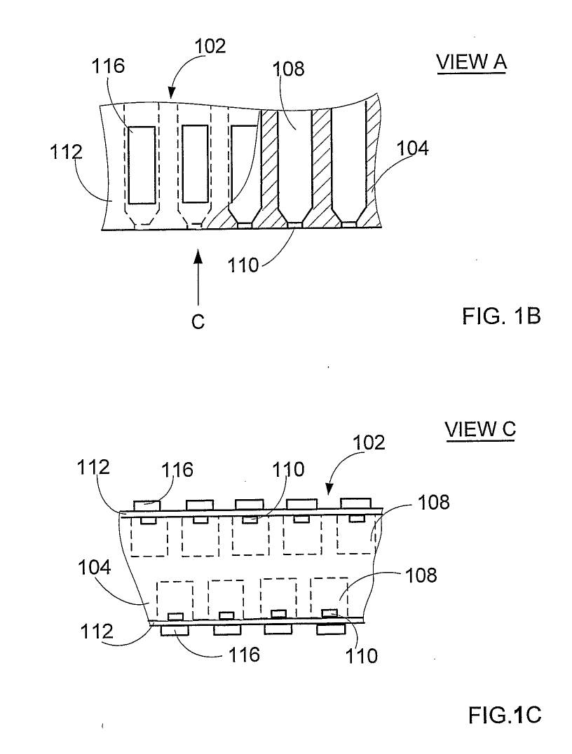

FIG. 1 is a schematic illustration of the first embodiment of an inkjet print head. Print head 100 includes a silicon micro machined chip 102 consisting of substrate 104 in which a plurality of ink ejecting channels 108 (FIG. 1B), each ending by a nozzle 110, is etched. A glass cover 112 covers ink-ejecting channels 108. A plurality of piezo ceramic actuators 116 (FIGS. 1B and 1C) is attached to glass cover 112. Each of the plurality of piezo ceramic actuators 116 is associated with respective ink ejecting channel 108. Epoxy or glue attaches substrate 104 to print head holder 120.

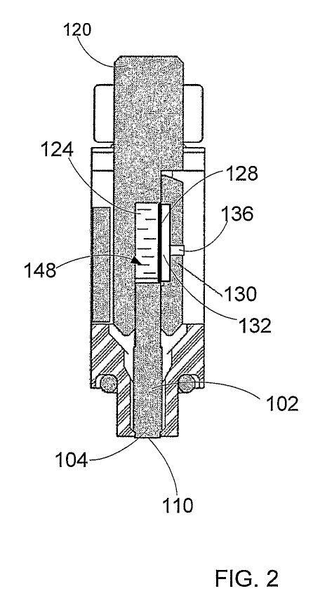

Holder 120 has a manifold 124 (FIG. 2) made as a recess in holder 120, for distributing ink to each of ink ejecting channels 108. One of the sidewalls 128 forming manifold 124, or at least a section of it, is made of flexible material. For protection purposes a rigid cover 130, is placed over flexible sidewall 128. There is a gap 132 between flexible sidewall 128 and cover 130. Cover 130 has one or more air communication ports 136 maintaining atmospheric pressure in gap 132. An ink supply port 140 (FIG. 1) with the help of tubing 142 connects manifold 124 with main or interim ink tank 144.

In a stand-by mode of operation ink ejecting channels 108, ink manifold 124 and tubing 142 are filed with ink 148. When print head 100 becomes operative, which may take place for example; at the beginning of the printing process the drop ejection process depletes ink 148 in print head 100. The process is known as “ink starvation.” Tank 144 replenishes ink 148, although the replenishment takes place only after a certain delay. Initially, the pressure of ink in the vicinity of nozzle 110 decreases, and negative pressure front proceeds through the print head and tubing 142 towards ink tank 144. The distance L from nozzles 110 to tank 144 and the speed of sound C in the ink define the delay (Delay=L/C (second)). Only after this delay, ink 148 begins to flow towards manifold 124 and ink ejecting channels 108 of print head 100. Until replenished ink 148 reaches ink-ejecting channels 108 and nozzles 110 the delay is further increased by the value of the time it takes the ink to travel the distance L. The delay between the start of printing process and the time replenishing ink fills-in the nozzles is 2 L/C second. This creates visible flaws in the printed image quality.

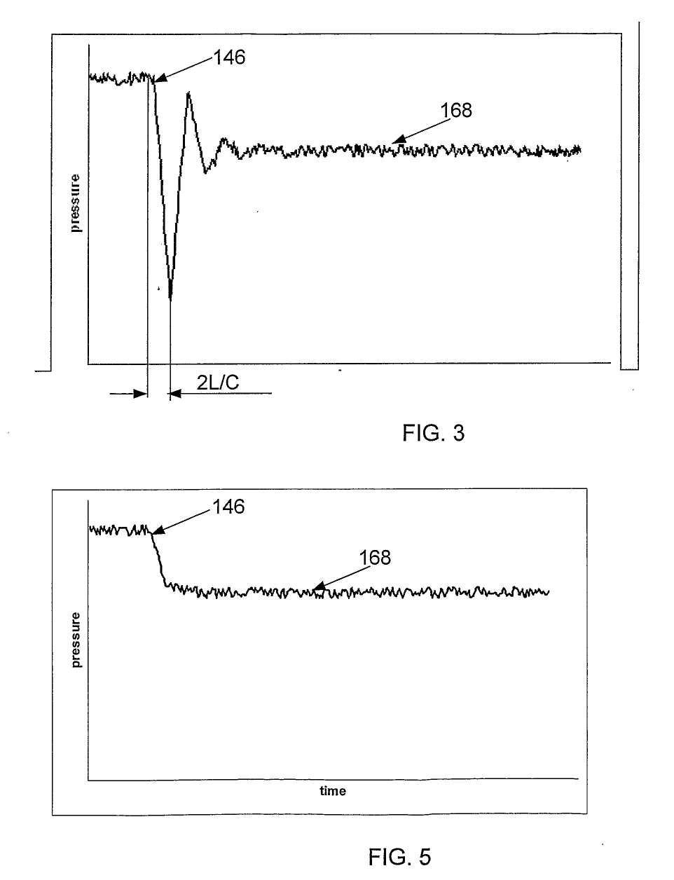

In conventional print heads having manifold with rigid sidewalls, immediately after the beginning of the operation of print head 100 the pressure, as illustrated in FIG. 3, falls abruptly to a very low level. If print head 100 continues to operate in course of this time and drop ejection continues, the pressure in the area of nozzles 110 continues to decrease. If the ink ejection frequency is high, the pressure in the nozzle area can decrease to a level where the ink meniscus in nozzles 110 will not be able to overcome it. At this instant the meniscus breaks and air is ingested into the nozzle, rendering it inoperable. After a delay of about 2 L/C second, the pressure, as shown by section 168 of the graph in FIG. 3, returns to an equilibrium position and normal print head operation is restored. However, the operation of nozzles 110 that were rendered to be not operable might not be restored.

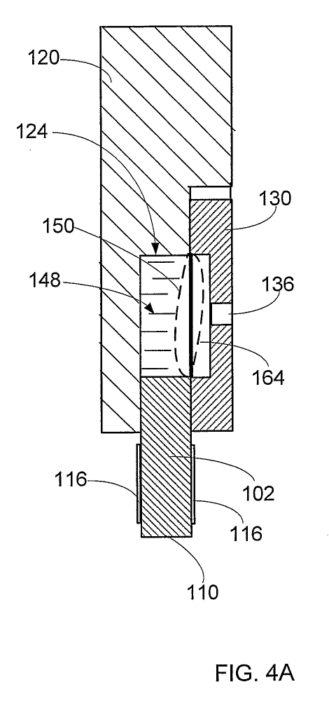

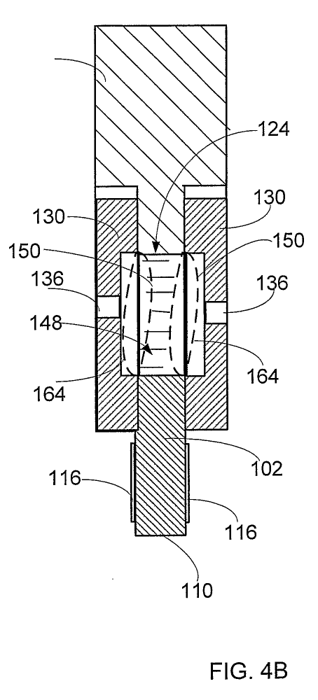

Flexible sidewall 128 allows reducing or even eliminating the pressure drop, shown in FIG. 3, and the associated with it nozzle failures. FIG. 4A is a schematic illustration demonstrating principles of operation of the flexible wall. With the decrease in ink pressure inside manifold 124, air at atmospheric pressure that enters through air communication port 136, deforms and bends inwards flexible sidewall 128 changing the volume of manifold 124 occupied by ink 148. The volume changes such that the pressure variations within the manifold are minimized and steady ink replenishment to nozzles continues.

Manifold 124 is located at a distance L′ from the location of nozzles 110. Distance L′ is much shorter than the distance to the ink tank L (L′<<L) and the time delay between the start of print head operation at the beginning of printing and ink replenishment (L′/C) is much shorter than in conventional print heads. FIG. 5 is a schematic illustration of the pressure changes within print head having a flexible sidewall at the beginning of print head operation. It shows that the pressure drop is significantly reduced and steady ink pressure 168 establishes itself almost immediately after onset of printing, eliminating potential nozzle failure.

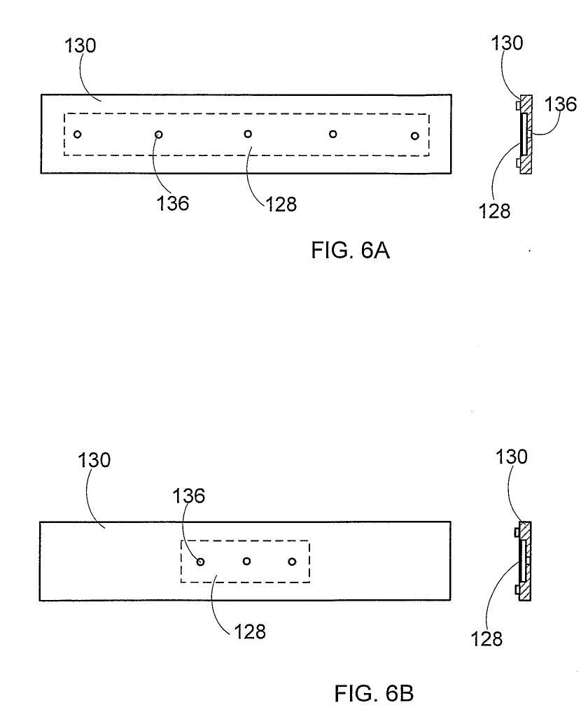

Flexible sidewall 128 (FIGS. 2 and 4) should be designed such that it immediately bends to occupy all of the volume released by ink 148 consumed by print head 100 operation in course of the delay 2 L/C. As the ink flow gradually replenishes the ink consumed, flexible sidewall 128 restores its original position. For proper functioning flexible sidewall 128 should have a surface being in contact with the ink and a modulus of elasticity sufficient to support sag of sidewall 128 proportional to the amount of ink displaced. These two parameters determine the amount of inward bending 150 (FIG. 4) for a given pressure difference across the flexible sidewall 128. Hence, flexible sidewall 128 may cover only a section of manifold 124. FIG. 6A illustrates a flexible sidewall 128 completely covering manifold 124 and FIG. 6B illustrates a flexible sidewall 128 covering only a section of manifold 124.

FIG. 4B illustrates another embodiment of a print head, where flexible sidewall 128 covers fully or partially both sides of manifold 124.

Flexible sidewall 128 should be chemically compatible with ink 128 and have low air permeability. It may be of a single layer or multi layer structure. Among materials suitable for the sidewall are ethylene vinyl acetate (EVA) or Mylar®, some types of Polyimide and others.

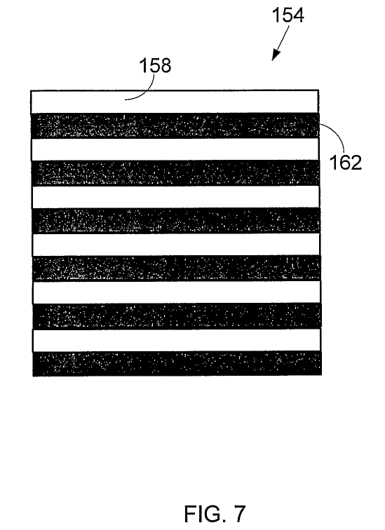

Sudden ink pressure changes occur not only at the beginning of printing or print head operation. They may occur at each printed pattern change. FIG. 7 shows a printed image 154 that contains multiple transitions from highlights 158 to shadows 162. Such transitions cause abrupt changes in the number of operative ink ejecting channels and associated with it nozzle failures. At the end of print head operation ink continues to flow towards the print head nozzles causing an increase in ink pressure and associated with it ink dripping. Flexible sidewall 128 bends outward 164 (FIG. 4A) increasing the volume available for the ink and prevents nozzle plate wetting and ink dripping.

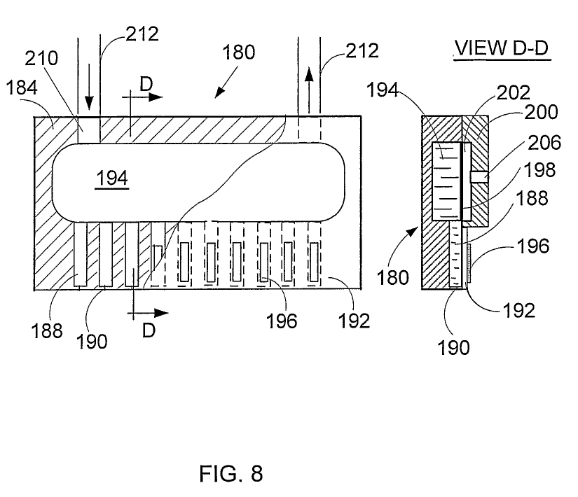

FIG. 8 is a schematic illustration of another embodiment of the inkjet print head having a flexible sidewall. Print head 180 is a micro machined chip consisting of silicon substrate 184 in which a plurality of ink ejecting channels 188 each ending by a nozzle 190 is etched. A glass cover 192 covers ink-ejecting channels 188. A plurality of piezo ceramic actuators 196 is attached to glass cover 192. Each of the plurality of piezo ceramic actuators 196 is associated with respective ink ejecting channel 188. Print head 180 further includes an etched in substrate 184 or otherwise produced manifold 194 for distributing ink to each of ink ejecting channels 188. A sidewall 198 made of flexible material covers manifold 194 or at least a section of it. Another rigid cover 200 is placed over sidewall 198. There is a gap 202 between cover 188 and cover 200. Cover 200 has one or more air communication ports 206 for maintaining atmospheric pressure in gap 202. An ink supply port 210 with the help of tubing 212 connects manifold 194 with main or interim ink tank (not shown). The operation of print head 180 is similar to the operation of print head 100 and was explained supra.

Relative movement between the print head and substrate, on which the image is printed, enables printing over the whole surface of the substrate. Print head, being lighter than the substrate, usually moves in a type of reciprocating movement over the substrate. Changes in the print head movement direction, vibrations caused by the motors and others cause changes in the pressure of the ink in ink delivery system and print head. Use of ink manifold covered by a flexible sidewall and located close to the nozzles of the print head significantly reduces these ink pressure variations and their effect on the print quality.

A number of embodiments have been described. Nevertheless, it will be understood that various modifications may be made without departing from the spirit and scope of the method. Accordingly, other embodiments are within the scope of the following claims:

1. An inkjet print head (100) for ejecting ink droplets, said head (100) comprising a micro machined chip (102), a holder (120) for holding the chip (102) and a manifold (124) made as a recess in the holder for distributing ink (148) to the micro machined chip (102) the manifold (124) characterized in that at least one of the sidewalls forming said manifold is a flexible sidewall (128).

2. The micro machined chip (102) according to claim 1, wherein said chip (102) comprises:
a) a substrate (104) with a plurality of ink ejecting channels (108) with each of said channels terminated by a nozzle (110);
b) at least one cover (112) covering said ink ejecting channels (108), and
c) a plurality of piezo ceramic actuators (116) each associated with respective ink ejecting channel (108).

3. The micro machined chip (102) according to claim 2, wherein said substrate (104) is a silicon substrate.

4. The micro machined chip (102) according to claim 2, wherein said cover (112) covering said ink-ejecting channels (108) is a glass cover.

5. The print head (100) according to claim 1, wherein said holder (120) is made of material different from said substrate (104).

6. The print head (100) according to claim 1, wherein said manifold (124) is located in close proximity to the ink-ejecting nozzles (110).

7. The print head (100) according to claim 1, wherein one side of said flexible sidewall (128) is in contact with ink (148) and the other side communicates with atmosphere.

8. The flexible sidewall (128) according to claim 7, wherein said flexible sidewall (128) is made of material chemically compatible with the ink (148).

9. The print head (100) according to claim 1, wherein said flexible sidewall (128) deforms with the changes in pressure of the ink (148) contained in said manifold (124).

10. The print head (100) according to claim 1, wherein said flexible sidewall (128) deformations change said manifold (124) volume such as to maintain the ink (148) pressure constant.

11. An inkjet print head (100) for ejecting an uninterrupted flow of ink droplets at sudden changes of print head (100) operational pattern, said head comprising a micro machined chip (102), a holder (120) for holding the chip (102) and a manifold (124) made as a recess in the holder (120) for distributing ink (148) to the micro machined chip (102) the manifold (124) characterized in that at least one of the sidewalls forming said manifold is a flexible sidewall (128) that deforms such that it maintains an ink supply necessary for an uninterrupted flow of ink droplets.

12. The micro machined chip (102) according to claim 11, wherein said chip (102) comprises:
a) a silicon substrate (104) with a plurality of ink ejecting channels (108) with each of said channels terminated by a nozzle (110);
b) at least one cover (112) covering said ink ejecting channels (108), and
c) a plurality of piezo ceramic actuators (116) each associated with respective ink ejecting channel (108).

13. The print head (100) according to claim 11, wherein said holder (120) is made of material different from said substrate (104).

14. The print head (100) of claim 11, wherein said manifold (124) is located in close proximity to the ink-ejecting nozzles (110).

15. A method of preventing an inkjet print head (120) operation failure caused by changes in ink pressure at sudden changes of said print head (120) operational pattern, characterized in that a flexible sidewall (128) forming ink manifold deforms and changes the volume of said ink manifold (124) such that it maintains ink (148) pressure constant when the operational pattern of said print head (100) changes.

16. The method according to claim 15, wherein said sudden changes in said operational pattern of said print head (100) take place at the beginning and the end of printing and at multiple highlight (158) shadow (162) transitions.

17. The method according to claim 15, wherein said print head (100) is a micro machined silicon print head further comprising a plurality of ink-ejecting channels (108) and a manifold (124) for ink (148) distribution to said channels (108), characterized in that said flexible sidewall (128) made of elastic material covers at least a section of said manifold (124).

18. A method of preventing an inkjet print head (100) operation failure caused by sudden changes in ink pressure at the beginning and end of printing, comprising providing an inkjet print head (100) having ink ejection channels (108) with each of said channels terminated by a nozzle and a manifold (124) for distributing ink to said channels (108), characterized in that said manifold (124) has a sidewall (130) having at least a section of it (128) flexible and that said flexible sidewall (128) deforms and changes the manifold volume such that it maintains ink pressure constant and prevents print head operational failure.

19. The method according to claim 18, characterized in that said ink manifold (124) is located in close proximity to the ink ejecting nozzles (110).

20. A method of preventing an operational failure of at least one of a plurality of nozzles of an inkjet print head caused by sudden changes in the operational pattern of said plurality of nozzles, comprising providing an inkjet print head having ink ejection nozzles and a manifold for distributing ink to said nozzles, characterized in that said manifold has a sidewall having at least a section of it flexible and said flexible section deforms as a function of said print head operational pattern and changes the volume of ink manifold such that it prevents nozzle operation failure.

21. An inkjet print head (180) comprising a substrate (184) having a plurality of ink ejecting channels (108) formed therein, the substrate further having a recess formed therein and forming a reservoir (194) for supplying ink (148) to the ink ejecting channels (108), characterized in that at least one of the sidewalls forming said reservoir is a flexible sidewall (198).
